(19) United States
(12) Patent Application Publication
(10) Pub. No.: US 2024/0140508 A1
(43) Pub. Date: May 2, 2024

(54) SIGNAL COMMUNICATION SYSTEM

(71) Applicant: Transportation IP Holdings, LLC, Norwalk, CT (US)

(72) Inventors: Jeffrey Donald Kernwein, Cedar Rapids, IA (US); Jeremy Blackwell, Cedar Rapids, IA (US); David Hill, Cedar Rapids, IA (US)

(21) Appl. No.: 18/479,303

(22) Filed: Oct. 2, 2023

Related U.S. Application Data
(60) Provisional application No. 63/421,197, filed on Nov. 1, 2022.

(51) Int. Cl. B61L 27/70; B61L 1/18; B61L 15/00

(52) U.S. Cl. CPC B61L 27/70; B61L 1/181; B61L 15/0027

(57) ABSTRACT

A signal communication system is provided that may include signaling lamp assembly, a receiver device, and a communication device. The signaling lamp assembly may include a lamp generating light indicative of a status of a wayside device The lamp may generate the light responsive to receiving an activation signal. The receiver may receive timing signals from one or more remote signal sources and output a time indication based on the timing signals that are received. The receiver may output the time indication responsive to the lamp receiving the activation signal. The communication device may send a status signal responsive to the lamp receiving the activation signal, the status signal indicating the status of the wayside device and the time indication.

### CROSS-REFERENCE TO RELATED APPLICATIONS

This application claims priority to U.S. Provisional Application No. 63/421,197, filed on Nov. 1, 2022, the entire disclosure of which is incorporated herein by reference.

### BACKGROUND

### Technical Field

The subject matter described herein relates to a signal communication system and method for a vehicle system.

### Discussion of Art

Vehicle systems may use the same routes for traffic going in two or more directions. Signals may be positioned at wayside positions adjacent the route. The wayside signals may indicate a track condition and may be used by engineers, dispatchers, computerized control systems and the like to control access to the route and prevent conflicting vehicle movements. Switches may be used along routes to change the vehicle's route. At the switch, the route may be mechanically moved to divert the vehicle to a new route. The wayside signals may include a light to indicate when the route is safe to travel (e.g., a green light) or when the route is not safe to travel (e.g., a red light). An operator of the vehicle may monitor the wayside signals to determine the status of the route.

While wayside signals with visual indicators are widely used, the visual indicators may only effectively convey the route status when the wayside signal is within the visual range or field of the vehicle and an operator of the vehicle. If the vehicle and operator of the vehicle are outside of the visual range of the wayside signal, the indication of route status by the wayside signal may not be effective. Additionally, due to the potential for operator error, it may be beneficial to have an additional method of communicating the wayside signals.

In order to communicate the wayside signals a greater distance, additional infrastructure may be needed to accommodate the components to communicate the signals, for example a radio and a wayside interface unit. Additionally, an independent power supply may be required to implement an independent communication system. This may be inconvenient and expensive to implement along certain routes. It may be desirable to have a system and method that differs from those that are currently available.

### BRIEF DESCRIPTION

In accordance with one example or aspect, a signaling communication system is provided including a signaling lamp assembly, a receiver device, and a communication device. The signaling lamp assembly may include a lamp that may generate light indicative of a status of a wayside device. The lamp may generate the light responsive to receiving an activation signal. The receiver device may receive timing signals from one or more remote signal sources and output a time indication based on the timing signals that are received. The receiver may output the time indication responsive to the lamp receiving the activation signal. The communication device may send a status signal responsive to the lamp receiving the activation signal. The status signal may indicate the status of the wayside device and the time indication.

In accordance with one example or aspect, a method is provided including generating light using a lamp of a signaling lamp assembly responsive to receiving an activation signal. The light may be indicative of a status of a wayside device. The method may include receiving timing signals at a receiver of the signaling lamp assembly from one or more remote signal sources. The method may include outputting a time indication based on the timing signals that may be received by the receiver. The time indication output may be responsive to the lamp receiving the activation signal. The method may include communicating a status signal responsive to the lamp receiving the activation signal using a communication device of the signaling lamp assembly. The status signal may indicate the status of the wayside device and the time indication.

In accordance with one example or aspect, a method is provided that may include generating a signal using a signaling assembly responsive to receiving an activation signal. The signal may be indicative of a status of a wayside device. The method may include receiving timing signals at a receiver of the signaling assembly from one or more remote signal sources. The method may include outputting a time indication based on the timing signals that may be received by the receiver. The time indication output may be responsive to the signaling assembly receiving the activation signal. The method may include communicating a status signal responsive to the signaling assembly receiving the activation signal using a communication device of the signaling assembly. The status signal may indicate the status of the wayside device and the time indication.

### BRIEF DESCRIPTION OF THE DRAWINGS

The subject matter may be understood from reading the following description of non-limiting embodiments, with reference to the attached drawings, wherein below:

FIG. 1 illustrates a signal communication system of a wayside device and a vehicle system, in accordance with one example;

FIG. 2 illustrates a signal communication system having a signaling lamp assembly, in accordance with one example;

FIG. 3 illustrates a flow chart of a method of signal communication of a wayside device to a vehicle, in accordance with one example; and

FIG. 4 illustrates a flow chart of a method of signal communication of a wayside device to a vehicle, in accordance with one example.

### DETAILED DESCRIPTION

Embodiments of the subject matter described herein relate to signal communication systems and methods for vehicle control systems. Embodiments of the subject matter described relate to a signaling device, such as a lamp assembly, that may generate a signal indicative of a status of a wayside device. The signaling device may include a lamp or display that may generate light indicative of a status of the wayside device. The light of the lamp may provide a visual indication to a vehicle or an operator of a vehicle of the status of the wayside device.

The signaling lamp may include a communication device. The communication device may communicate the status of the wayside device to a vehicle control system. By communicating the status of the wayside device to the vehicle control system, the vehicle control system may be able to determine the status of the wayside device in advance of the vehicle reaching the wayside device. The range of the communication device may be greater than the visual range of the operator of the vehicle to see the lamp. This may allow the operator and/or the vehicle control system to control movement of the vehicle more effectively.

In one embodiment, the signaling lamp may be a retrofit kit that is designed such that the signaling lamp may replace a bulb of an existing wayside device. The signaling lamp may be powered by the existing electrical infrastructure of the existing wayside device. Additionally, the signaling lamp may be sized and shaped such that the signaling lamp may fit within a recess that previously held the bulb of the existing wayside device. This system and method may extend a useful range of the vehicle control system while not requiring expensive and/or laborious additions of infrastructure and components.

A suitable lamp may include an incandescent bulb or a light emitting diode (LED), or another light producing device; and, these may be singular or an array of light emitters. In embodiments with a plurality of emitters, these may work to create a homogeneous image (a fully red light, a fully green light, a fully yellow light) or may form a patterned image (e.g., a cross, a dash, a circle, an X). In one embodiment, the formed image may be static, or in another embodiment may be alternative on/off to form the optical effect of motion or blinking (e.g., a wash screen, a blinking X, an expanding or collapsing circle). The lamp may electrically connect to the existing wiring inside of the housing, and may be mechanically supported in a similar fashion. The light emitting portion may extend outside of the housing and form a larger display surface than what would fit within the housing. A protecting transparent shell may protect the light emitters.

While one or more embodiments are described in connection with rail vehicles and/or rail vehicle systems, other embodiments are not connected to rail vehicles and rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

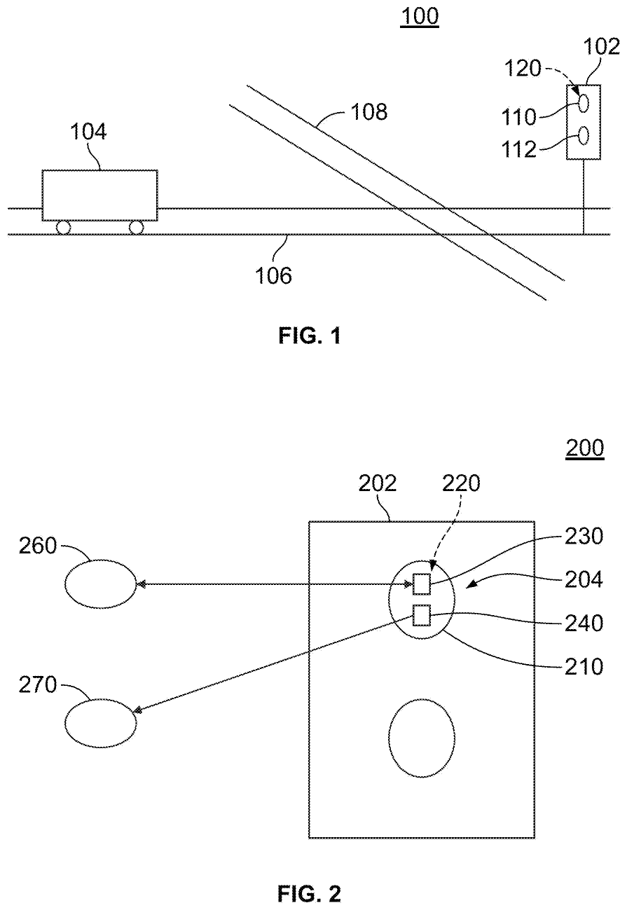

FIG. 1 illustrates a signal communication system 100 of a wayside device 102 and a vehicle system 104, according to one example. The vehicle system may travel along one or more routes 106, 108. The routes, as shown in FIG. 1, may cross at one or more points. The wayside device may be positioned near an intersection of the routes. The wayside device may include one or more lamp bulbs 110 and 112. The color of the lamp bulb may communicate the status of the route(s) to the upcoming vehicles. In one example one lamp bulb, for example 112, may be a green lamp bulb indicating that the route(s) may be suitable for travel by the vehicle system. Another lamp bulb, for example 110, may be a red lamp bulb and may indicate that the route(s) may not be suitable for travel by the vehicle system. One lamp bulb may be a yellow lamp bulb and may indicate that the route(s) may be suitable for travel by the vehicle system under limited circumstances, for example, at a reduced speed. The lamp bulbs may be different colors or may change colors.

The lamp bulb may be sized to be inserted into a recess 120 or socket of the wayside device. The wayside device may be positioned adjacent to the route being travelled by vehicles. The wayside device may receive an activation signal indicating that the route or routes may be suitable for travel by an upcoming vehicle. The route or routes may be suitable for travel by an upcoming vehicle when the route or routes may not be presently occupied by an obstruction, for example a different vehicle or vehicle system, pedestrian, maintenance worker, or the like. Further, the route or routes may be suitable for travel by an upcoming vehicle when the route or routes may be expected to not be occupied by an obstruction when the upcoming vehicle may be anticipated to occupy or travel along the route or routes. The activation signal may be provided by an offboard control center, a controller, an operator, one or more sensors, or the like.

The wayside device may then light up the lamp bulb to generate a light indicative of the status of the wayside device. The illuminated lamp bulb may provide an indication to an operator of the upcoming vehicle that the route may be suitable for travel by the vehicle, for example, the green lamp bulb may be illuminated to indicate that the route may be suitable for travel. In another example, the red lamp bulb may be illuminated to provide an indication to the operator of the upcoming vehicle that the route may not be suitable for travel by the vehicle. The yellow lamp bulb may be illuminated to provide an indication to the operator of the upcoming vehicle that the route may be suitable for travel by the vehicle under limited circumstances, for example at a reduced speed.

The wayside device described above may rely on the vision of the operator to receive the signal indicating whether the route may be suitable for travel. Thus, the usefulness of the wayside device may be limited to the range of vision of the operator. This may be further limited where environmental conditions reduce visibility, such as rain, snow, fog, debris, or the like. Additionally, the responsibility for identifying the status of the wayside device may rest primarily on the operator and any onboard control systems may not be able to effectively receive the visual signal from the wayside device.

In order to communicate the wayside device signal to a vehicle control system, a communication device may be used. A suitable communication device may be, for example, a radio. A suitable radio frequency may be, e.g., about 220 MHZ. A wayside interface unit may be used to communicate the signal directly to the vehicle control system. Alternatively or additionally, a wayside status relay service (WSRS) may be used to communicate the wayside device signal to a back-office control system. The back-office may then communicate the wayside device signal to the vehicle control system. In one embodiment, the communication device is collocated with the lamp device and obtains its power from the same source—thus, in this embodiment, the lamp and communication functions may be a simple replacement into the location of the older bulb. In one embodiment, the communication device communicates with the vehicle system and can be used in a wireless crossing system in addition to the functionality of the visual indications.

FIG. 2 illustrates one example of signal communication system 200 that may include a wayside device 202 having a signaling lamp assembly 204. The signaling lamp assembly may include a lamp 210, a receiver 230, and a communication device 240. The communication device may communicate with a vehicle control system 270 or an operator of a vehicle or vehicle system. The signaling lamp assembly may be sized to be inserted into a recess 220 or socket of the wayside device. In one example, the lamp may generate light of a designated color to indicate the status of a light signal as the wayside device in response to receiving an activation signal. The activation signal may indicate whether the route or routes may be suitable for travel by an upcoming vehicle. The lamp may generate a single color, such as red, green, or yellow, to indicate the status of the wayside device. The green light may indicate a permissive, explicit indicator that the route may be suitable for the vehicle to travel on. The red light may indicate that the route may not be suitable for the vehicle to travel on. The yellow light may indicate that the route may be suitable for the vehicle to travel on in limited circumstances. The light indicating the status of the route may be communicated to the vehicle control system.

The vehicle control system may include controllers, microcontrollers, processors, microprocessors, or other logic devices that operate based on instructions stored on a tangible and non-transitory computer readable storage medium, such as software applications stored on a memory. If a system, apparatus, assembly, device, etc. (e.g., vehicle control system, a controller, control device, control unit, etc.) includes multiple processors, these processors may be located in the same housing or enclosure (e.g., in the same device) or may be distributed among or between two or more housings or enclosures (e.g., in different devices). The multiple processors in the same or different devices may each perform the same functions described herein, or the multiple processors in the same or different devices may share performance of the functions described herein. For example, different processors may perform different sets or groups of the functions described herein.

As used herein, the term “receiver” includes an electronic circuit that is capable of receiving radio signal inputs, separating the wanted radio signal from all other picked-up radio signals, amplifying the signal to a level suitable for processing and converting the signal through demodulation and decoding into usable form. In one example, the receiver device may include a navigation system receiver or a positioning system receiver, for example a Global Navigation Satellite System (GNSS) receiver. The GNSS receiver may provide the geographic location of the wayside device. It should also be understood that transmitter and receiver combination “transceivers” are also contemplated for the receivers of this application.

The communication device may include or represent an antenna (along with associated transceiver hardware circuitry and/or software applications) for wirelessly communicating with other vehicles and/or remote locations. Optionally, the communication device may communicate via one or more wired connections, such as a multiple unit (MU) cable, a trainline, an electrically controlled pneumatic (ECP) brake line, or the like. The communication device may include a radio transmitter. In one example, the radio transmitter may be a low-power radio and an integrated antenna. The communication device may communicate with one or more other vehicle systems and/or other remote locations that may be offboard the vehicle.

In one example, the status of the wayside device may be determined by one or more sensors indicating a route characteristic or route characteristics. The sensors may include electrical sensors and/or mechanical sensors. The electrical sensors may measure a switch disposed at an intersection between two or more routes. Switches may be placed throughout the route to divert traffic from a main route to side routes (sidings) allowing vehicles to pass one another or to change the vehicle's route. At the switch, the routes of may be mechanically moved to successfully divert the vehicle to the new route. The operator may visually monitor wayside devices to determine the status of the switches and to obtain authority to enter a specific route section and takes action, for instance adjusting the speed of the vehicle when signals indicate the vehicle may be diverted to a siding due to switch positions indicated by the one or more sensors.

Electrical sensors may include an ohmmeter measuring electrical resistance indicating an open or closed position of the switch. Other electrical sensors may include a voltmeter measuring electrical potential in volts, an impedance analyzer measuring impedance, an ammeter measuring current, a database or memory, an input device (e.g., control panel, switch, keyboard, microphone, etc.), or the like. Mechanical sensors may measure a physical characteristic of the route. Mechanical sensors may include an optical sensor (e.g., an infrared sensor, a camera, a proximity detector) that may scan, read, or otherwise identify an identifying marker. The identifying marker can be indicia printed on a vehicle, a wayside device, a portion of the route, or the like. In one example, the identifying marker may be associated with an obstruction along the route. In another example, the identifying marker may be associated with a portion of the route and may be associated with no obstruction of the route, as the identifying marker may be read rather than be obstructed. Other mechanical sensors may include an acoustic sensor (e.g., an ultrasonic sensor), a capacitive sensor, a photoelectric sensor, an inductive sensor, a laser distance sensor (e.g., Light Detection and Raging “LIDAR”), or the like.

Based on the inputs from the one or more sensors, the activation signal indicative of the status of the wayside device may be sent to the lamp. The activation signal may indicate that a certain portion of the route may be suitable for an upcoming vehicle or may not be suitable for an upcoming vehicle. Whether the route may be suitable for the upcoming vehicle may be based on the traffic along the route, the route characteristics, vehicle characteristics, weather conditions, among other factors.

In one example, the activation signal may be an electric power to power the signaling lamp. The signaling lamp assembly may be powered by the same infrastructure that powered the lamp bulb of the wayside device shown in FIG. 1. By using existing infrastructure to power the signaling lamp assembly, the number of components, cost, and difficulty of installation all may be greatly reduced. The signaling lamp assembly may be powered based on the same indications that would power the lamp bulb of the previously described wayside device. Said another way, the same activation signal that determines the illumination of the lamp bulb to indicate the status of the wayside device described in FIG. 1 may be the same activation signal that determines the status of the wayside device described in FIG. 2. The lamp of the signaling lamp assembly may only generate light indicative of the status of the wayside device in response to receiving the activation signal. If the lamp does not receive the activation signal, the lamp may not generate light.

The receiver and the communication device may be activated while the lamp receives the activation signal. Said another way, the receiver and the communication device may only be powered while the lamp receives the electric power to power the lamp and receive the activation signal. This may prevent the receiver and the communication device from sending a false message when the activation signal has not been received by the lamp. The signaling lamp assembly may communicate the status of the wayside device when there may be an active change or status update by activating the lamp.

The receiver and the communication device may communicate the status of the wayside device to an upcoming vehicle, in addition to the lamp visually indicating the status of the wayside device. The receiver and the communication device may communicate the status of the wayside device to an onboard operator of the upcoming vehicle, to the onboard vehicle control system, to an offboard vehicle control system, to an offboard operator of the upcoming vehicle, to an offboard controller, or the like. In one example, the receiver and the communication device may be able to communicate the status of the wayside device a distance greater than the visual range from which the lamp may be seen from the vehicle. For example, the receiver and the communication device may communicate the status of the wayside device to the vehicle several miles before the vehicle may be set to arrive at the wayside device. The advance notice of the status of the wayside device may allow the operator or the vehicle control system to make adjustments to the travel of the vehicle well in advance of the wayside device to increase efficiency and safety of the vehicle travel. Further, if the onboard operator or the vehicle control system do not receive an explicit signal from the wayside device that the route may be suitable for travel, the onboard operator and/or the vehicle control system may be able to take a responsive action in advance of arriving at the wayside device. The responsive action may include the onboard operator and/or the vehicle control system slowing or stopping the vehicle, communicating with an offboard operator or control system, changing the route of the vehicle in advance of reaching the wayside device, or the like.

The receiver and the communication device may be deactivated while the lamp does not receive the activation signal. By deactivating the receiver and the communication device while the lamp does not receive the activation signal, the signaling lamp assembly may reduce the burden on the communication channels by reducing the overall radio frequency being transmitted. Additionally, deactivation in response to not receiving the activation signal may reduce the likelihood of a false message transmission by the communication device. The receiver and the communication device may be arranged to be activated only when an activation signal may be received by the lamp.

In the embodiment illustrated in FIG. 2, the receiver and the communication device may be positioned within the lamp. In another example, the receiver and the communication device may be positioned elsewhere, such as in an outer housing shaped to fit within a recess of the wayside device. Where the receiver and communication device are positioned within the lamp or within the wayside device, the overall footprint required to have the communication device may be reduced and the overall additional infrastructure needed may also be reduced. The receiver and the communication device may be positioned outside the lamp, for example at an offboard control center or in a wayside device separate from the signaling lamp assembly.

The receiver may receive signals from one or more remote signal sources 260. In one example, the remote signal sources may be satellites, a signal from an offboard control center, an offboard crew member, or the like. In one example, the signals may be timing signals. The timing signals may be a time component of the activation signal. Said another way, the timing signals may be a time at which the activation signal was received. The timing signals may be a time at which a security code was received by the remote signal sources. The timing signals may validate the timeliness of the signals received to ensure that the signals received may be current or within a threshold time range of the signal being sent. The timing signals may allow the receiver to output a time indication to the vehicle control system. The time indication may be output by the receiver responsive to the lamp receiving the activation signal. The receiver device may determine a geographic location of the wayside device by using a navigation system or position system, for example a GNSS receiver, another wireless triangulation system, or the like. The geographic location may be based on the timing signals received by the receiver from the wayside device. The receiver may use a known location of the wayside device as the geographic location. In one example, the receiver device may include a GNSS receiver. The GNSS receiver may provide the geographic location of the wayside device.

The communication device may send a status signal in response to the lamp receiving the activation signal. The status signal may indicate the status of the wayside device from the lamp and the time indication from the receiver. The status signal may be sent to the vehicle control system or the operator of the vehicle. Because the status signal may represent a “yes” or “no” to whether the lamp has received the activation signal, the status signal may be a brief message that may not require substantial bandwidth to communicate. This may preserve bandwidth for other communication requirements of the vehicle systems or the wayside devices.

In one example, the vehicle control system may be an onboard positive vehicle control (PVC) system. The PVC system may be a control system in which a vehicle system may be allowed to move, and/or may be allowed to move outside a designated restricted manner (such as above a designated penalty speed limit), only responsive to receipt or continued receipt of one or more signals (e.g., received from offboard the vehicle) that meet designated criteria, e.g., the signals have designated characteristics (e.g., a designated waveform and/or content) and/or are received at designated times (or according to other designated time criteria) and/or under designated conditions. The PVC system may include information about the route or the vehicle system, for example, a projected trip plan, a route database, a length of the route, a curvature of the route, a number of vehicles in the vehicle system, a speed of the vehicle system, or the like. In one example, the vehicle control system may include a negative vehicle Control (NVC) system. The NVC may allow a vehicle to move unless a signal (restricting movement) may be received.

The status signal may be sent to the onboard PVC component of the vehicle. The status signal may provide the PVC system with a predictive enforcement means of non-permissive signals in advance of the vehicle arriving at the wayside device. Said another way, the status signal may give the PVC system advanced notice of the status of the wayside device and may allow the PVC system to make decisions about movement of the vehicle prior to arriving at the wayside device. The PVC may include an integrated command, control, communications, and information system for controlling vehicle movements with safety, security, precision, and efficiency. The PVC system may enforce travel restrictions including movement authorities that may prevent unwarranted movement of the vehicle. Based on travel information generated by the vehicle and/or received through the communication device, the PVC system may determine the location of the vehicle and whether and how fast the vehicle can travel based on the travel restrictions, and may determine if movement enforcement may be performed to adjust the speed of the vehicle (including ordering a full stop).

The time indication portion of the status signal may allow the vehicle control system to verify that the status signal may be current and applicable to the given time and route. The status signal may include additional information. For example, the status signal may include an identification number unique to the communication device or the vehicle. The vehicle control system may be programmed with knowledge of various wayside devices and the unique identification number associated with each wayside device. The identification number may allow the vehicle control system to identify the communication device sending the status signal. The identification of the communication device may allow the vehicle control system to verify the location of the communication device along the route. In one example, the vehicle control device may require the use of an authentication code for security purposes. The authentication code may include the identification number and a non-repeating number, such as the time indication. Once the authentication code has been verified, the vehicle control system may read the status signal.

The communication device may wirelessly send the status signal to one or more vehicles, for example, the upcoming vehicle approaching the wayside device. The wireless communication may be satellite communication, infrared communication, radio communication, Wi-Fi communication, Bluetooth communication, mobile communication, or the like. The communication device may wirelessly send the status signal to the vehicle while the signaling lamp assembly may not be visible to the one or more vehicles. As discussed, this may allow the vehicle to make decisions about travelling along the upcoming route in advance of the vehicle being able to see the upcoming route.

The communication device may send the status signal of the wayside device to indicate a state of a switch disposed at an intersection between two or more routes. The communication device may receive a status of the switch from the vehicle control system based on one or more sensor outputs associated with the switch. The state of the switch disposed at the intersection may indicate whether another vehicle may be approaching the intersection, which may indicate that the route may not be safe for the upcoming vehicle to travel at a current speed. The status signal may prevent conflicting vehicle movements.

In one example, the signaling lamp assembly may include one or more lamps. Each of the one or more lamps may include a receiver and a communication device. Each lamp may generate light responsive to different inputs. For example, a first lamp may generate light responsive to the status of the wayside signal device being suitable for travel. A second lamp may generate light responsive to the status of the wayside signal device being not suitable for travel. A third lamp may generate a light responsive to the status of the wayside signal device being suitable for travel at a reduced speed. Each of the lamps and corresponding receivers and communication devices may communicate independently with the vehicle control system. This may allow for the PVC system of the vehicle to receive the signals indicating the route may be suitable for travel and/or suitable for travel at reduced speed. The NVC system may receive the signal indicating the route may not suitable for travel.

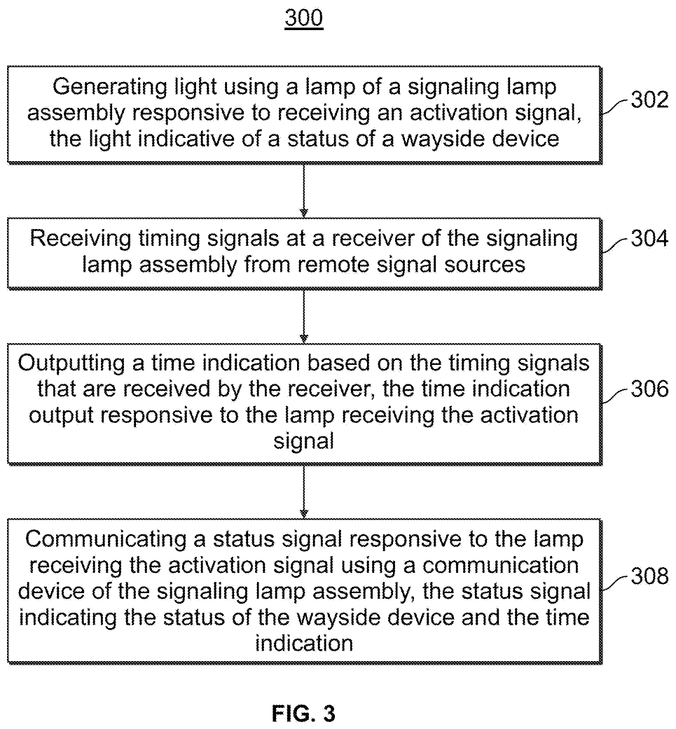

FIG. 3 illustrates a method 300 of signal communication of a wayside device to a vehicle, according to one example. The signal communication of the wayside device to the vehicle may provide the vehicle information regarding the status of the wayside device and an adjacent or nearby route upon which the vehicle may be set to travel.

At step 302, the method may include generating light using a lamp of a signaling lamp assembly responsive to receiving an activation signal. The light may be indicative of a status of a wayside device. The status of the wayside device may indicate that the route may be suitable for travel by the upcoming vehicle at a current speed, at a reduced speed, or that the route may not be suitable for travel by the upcoming vehicle. In one example, the light generated may be a designated color to indicate the status of a light signal as the wayside device. For example, the light may be green when the route may be suitable for travel, the light may be red when the route may not be suitable for travel, or the light may be yellow when the route may be suitable for travel at a reduced speed.

At step 304, the method may include receiving timing signals at a receiver of the signaling lamp assembly from remote signal sources. In one example, the remote signal sources may be satellites. In one example, the receiver may include a GNSS receiver to indicate a geographic location of the wayside device.

At step 306, the method may include outputting a time indication based on the timing signals that may be received by the receiver. The time indication output may be responsive to the lamp receiving the activation signal. In one example, the timing signals may be received only while the lamp receives the activation signal. The timing signals may not be received while the lamp does not receive the activation signal.

At step 308, the method may include communicating a status signal responsive to the lamp receiving the activation signal using a communication device of the signaling lamp assembly. The status signal may indicate the status of the wayside device and the time indication. In one example, the communication device may include a radio and an antenna. The status signal may be communicated as a radio signal. The status signal may be wirelessly transmitted or broadcast to one or more vehicles. The status signal may be communicated to the vehicle while the signaling lamp is not visible to the vehicle. In one example, the status signal may be communicated to indicate a state of a switch disposed at an intersection between two or more routes.

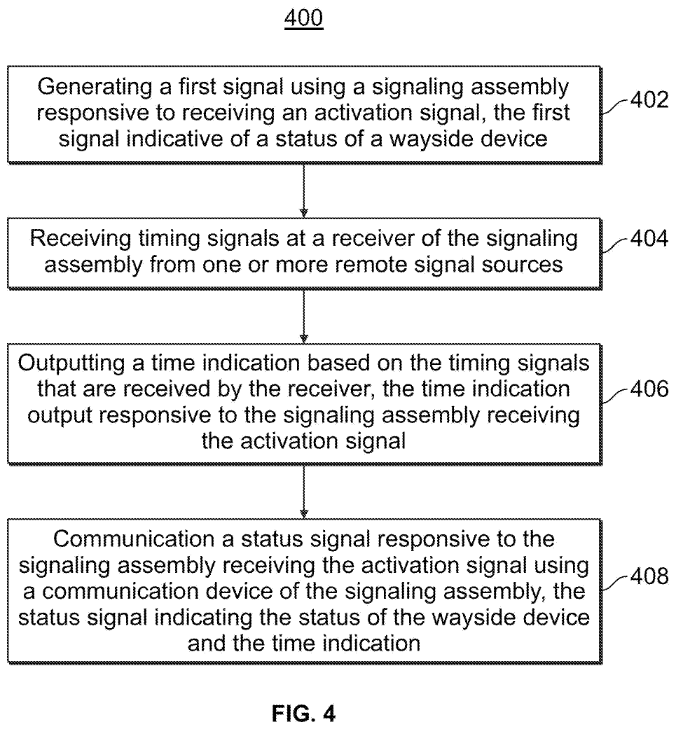

FIG. 4 illustrates a method 400 of signal communication of a wayside device to a vehicle, according to one example. The signal communication of the wayside device to the vehicle may provide the vehicle information regarding the status of the wayside device and an adjacent or nearby route upon which the vehicle may be set to travel. The signal communication may be used as part of a wireless crossing system that may provide the information regarding the status of the wayside device to a controller or control system of one or more vehicles.

At step 402, the method may include generating a first signal using a signaling assembly responsive to receiving an activation signal. The signal may be indicative of a status of a wayside device. The status of the wayside device may indicate that the route may be suitable for travel by the upcoming vehicle at a current speed, at a reduced speed, or that the route may not be suitable for travel by the upcoming vehicle. In one example, the signal generated may be a designated symbol, noise, message, or the like to indicate the status of the signaling assembly as the wayside device. For example, the signal may be an arrow or a checkmark when the route may be suitable for travel, the light may be an “X” or a stop sign when the route may not be suitable for travel, or the light may be a flashing triangle when the route may be suitable for travel at a reduced speed.

At step 404, the method may include receiving timing signals at a receiver of the signaling assembly from remote signal sources. In one example, the remote signal sources may be satellites. In one example, the receiver may include a GNSS receiver to indicate a geographic location of the wayside device.

At step 406, the method may include outputting a time indication based on the timing signals that may be received by the receiver. The time indication output may be responsive to the signaling assembly receiving the activation signal. In one example, the timing signals may be received only while the signaling assembly receives the activation signal. The timing signals may not be received while the signaling assembly does not receive the activation signal.

At step 408, the method may include communicating a status signal responsive to the signaling assembly receiving the activation signal using a communication device of the signaling assembly. The status signal may be sent to an operator of the vehicle, an onboard control system, an offboard control system, a PVC system, or the like. The status signal may indicate the status of the wayside device and the time indication. In one example, the communication device may include a radio and an antenna. The status signal may be communicated as a radio signal. The status signal may be wirelessly transmitted or broadcast to one or more vehicles as part of a wireless crossing system. The status signal may be communicated to the vehicle while the signaling assembly is not visible to the vehicle. In one example, the status signal may be communicated to indicate a state of one or more switches disposed at an intersection between two or more routes. The status signal may be sent whenever an alignment of the switches changes. The alignment of the switch or switches may be indicative of whether the route is suitable for travel by an upcoming vehicle. The status signal may be sent responsive to a vehicle approaching the signaling assembly.

In one embodiment, the communication system may have a local data collection system deployed that may use machine learning to enable derivation-based learning outcomes. A controller may learn from and make decisions on a set of data (including data provided by various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the communication system may include a policy engine that may apply one or more policies. These policies may be based at least in part on characteristics of a given item of equipment or environment. With respect to communication policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan and avoiding interference/collisions with other vehicles or vehicle groups. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the control system executes that plan to achieve the desired input data to mirror the predicted best outcome scenario. Additionally, the success metric may be a combination of the optimized outcomes, which may be weighed relative to each other.

The communication system can use this artificial intelligence or machine learning to receive input (e.g., a status of the wayside device), use a model that associates the status of the wayside device with different operating modes to select an operating mode of the one or more functional devices of the vehicle or vehicle system, and then provide an output (e.g., the operating mode selected using the model). The control system may receive additional input of the change in operating mode that was selected, such as analysis of noise or interference in communication signals (or a lack thereof), operator input, or the like, that indicates whether the machine-selected operating mode provided a desirable outcome or not. Based on this additional input, the controller can change the model, such as by changing which operating mode would be selected when a similar or identical wayside device status is received the next time or iteration. The controller can then use the changed or updated model again to select an operating mode, receive feedback on the selected operating mode, change or update the model again, etc., in additional iterations to repeatedly improve or change the model using artificial intelligence or machine learning.

In accordance with one example or aspect, a signal communication system is provided that may include a signaling lamp assembly, a receiver device, and a communication device. The signaling lamp assembly may include a lamp that may generate light indicative of a status of a wayside device. The lamp may generate the light responsive to receiving an activation signal. The receiver device may receive timing signals from one or more remote signal sources and output a time indication based on the timing signals that are received. The receiver may output the time indication responsive to the lamp receiving the activation signal. The communication device may send a status signal responsive to the lamp receiving the activation signal. The status signal may indicate the status of the wayside device and the time indication.

The lamp, the receiver device, and the communication device may be disposed within an outer housing shaped to fit entirely within a recess of the wayside device. The receiver device and the communication device may be activated while the lamp receives the activation signal. The receiver device and the communication device may be deactivated while the lamp does not receive the activation signal. The lamp may generate the light of a designated color or pattern to indicate the status of a light signal as the wayside device. The receiver device may include a location device, for example a Global Navigation Satellite System (GNSS) receiver. The communication device may include a radio transmitter. The communication device may send the status signal to indicate a state of a switch disposed at an intersection between two or more routes.

The receiver device may determine a geographic location based on the timing signals and the communication device may send the geographic location in the status signal. The communication device may send a unique identifier in the status signal. The communication device may wirelessly send the status signal to one or more vehicles. The communication device may wirelessly send the status signal to the one or more vehicles while the signaling lamp assembly may not be visible to the one or more vehicles.

In accordance with one example or aspect, a method is provided that may include generating light using a lamp of a signaling lamp assembly responsive to receiving an activation signal. The light may be indicative of a status of a wayside device. The method may include receiving timing signals at a receiver of the signaling lamp assembly from one or more remote signal sources. The method may include outputting a time indication based on the timing signals that may be received by the receiver. The time indication output may be responsive to the lamp receiving the activation signal. The method may include communicating a status signal responsive to the lamp receiving the activation signal using a communication device of the signaling lamp assembly. The status signal may indicate the status of the wayside device and the time indication.

The time indication and the status signal may be generated while the lamp receives the activation signal. The time indication and the status signal may not be generated while the lamp does not receive the activation signal. The light may be generated to be of a designated color to indicate the status of a light signal as the wayside device. The status signal may be communicated as a radio signal. The status signal may be communicated to indicate a state of a switch disposed at an intersection between two or more routes.

The method may include determining a geographic location based on the timing signals and sending the geographic location in the status signal. The status signal may be wirelessly transmitted or broadcast to one or more vehicles. The status signal may be wirelessly communicated to the one or more vehicles while the signaling lamp assembly may not be visible to the one or more vehicles.

In accordance with one example or aspect, a method is provided that may include generating a signal using a signaling assembly responsive to receiving an activation signal. The signal may be indicative of a status of a wayside device. The method may include receiving timing signals at a receiver of the signaling assembly from one or more remote signal sources. The method may include outputting a time indication based on the timing signals that may be received by the receiver. The time indication output may be responsive to the signaling assembly receiving the activation signal. The method may include communicating a status signal responsive to the signaling assembly receiving the activation signal using a communication device of the signaling assembly. The status signal may indicate the status of the wayside device and the time indication.

In one example, the method may include wirelessly transmitting or broadcasting the status signal to one or more vehicles.

In accordance with one example or aspect, a signaling lamp assembly is provided that may include a lamp, a receiver device, and a communication device. The lamp may generate light indicative of a status of a wayside signal device. The lamp may generate the light responsive to receiving electric power to power the lamp. The receiver device may receive timing signals from one or more satellites and output a time indication based on the timing signals that are received. The receiver may output the time indication responsive to the lamp receiving the electric power. The communication device may send a status signal to an onboard PVC component of a vehicle responsive to the lamp receiving the electric power. The status signal may indicate the status of the wayside device and the time indication.

The lamp, the receiver device, and the communication device may have a portion that is sized and shaped to be disposed within an outer housing. It may be shaped to fit at least a portion within a recess of the wayside device that previously held another lamp. In one embodiment, it is entirely fit within the existing housing. In another embodiment, it has a portion that extends into the housing to be electrically coupled and mechanically supported, and a display portion is outside of the housing and may be, in one instance, much larger of a display area than the housing's diameter. Accordingly, an oversized display may be used in the kit to replace the older bulb design.

In accordance with one example or aspect, a signaling lamp assembly is provided including a lamp, a receiver device, and a communication device. The lamp may generate light indicative of a status of a wayside signal device. The lamp may generate the light responsive to receiving electric power to power the lamp. The receiver device may receive timing signals from one or more satellites and output a time indication based on the timing signals that are received. The receiver may output the time indication responsive to the lamp receiving the electric power. The communication device may send a status signal to an onboard positive vehicle control (PVC) component of a vehicle responsive to the lamp receiving the electric power. The status signal may indicate the status of the wayside device and the time indication.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. The scope of the subject matter should, therefore, be determined with reference to the appended claims, along with the full scope of equivalents to which such claims are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A signal communication system, comprising:
a signaling lamp assembly including a lamp configured to generate light indicative of a status of a wayside device, the lamp configured to generate the light responsive to receiving an activation signal;
a receiver device configured to receive timing signals from one or more remote signal sources, and to output a time indication based on the timing signals that are received, the receiver configured to output the time indication responsive to the lamp receiving the activation signal; and
a communication device configured to send a status signal responsive to the lamp receiving the activation signal, the status signal indicating the status of the wayside device and the time indication.

2. The signal communication system of claim 1, wherein the lamp, the receiver device, and the communication device are configured to be disposed within an outer housing shaped to fit entirely within a recess of the wayside device.

3. The signal communication system of claim 1, wherein the receiver device and the communication device are configured to be activated while the lamp receives the activation signal, and the receiver device and the communication device are configured to be deactivated while the lamp does not receive the activation signal.

4. The signal communication system of claim 1, wherein the lamp is configured to generate the light in a designated color or pattern to indicate the status of a light signal as the wayside device.

5. The signal communication system of claim 1, wherein the receiver device includes a location device.

6. The signal communication system of claim 1, wherein the communication device includes a radio transmitter.

7. The signal communication system of claim 1, wherein the communication device is configured to send the status signal to indicate a state of a switch disposed at an intersection between two or more routes.

8. The signal communication system of claim 1, wherein the receiver device is configured to determine a geographic location based on the timing signals and the communication device is configured to send the geographic location in the status signal.

9. The signal communication system of claim 1, wherein the communication device is configured to send a unique identifier in the status signal.

10. The signal communication system of claim 1, wherein the communication device is configured to wirelessly send the status signal to one or more vehicles.

11. The signal communication system of claim 10, wherein the communication device is configured to wirelessly send the status signal to the one or more vehicles while the signaling lamp assembly is not visible to the one or more vehicles.

12. A method, comprising:
generating light using a lamp of a signaling lamp assembly responsive to receiving an activation signal, the light indicative of a status of a wayside device;
receiving timing signals at a receiver of the signaling lamp assembly from one or more remote signal sources;
outputting a time indication based on the timing signals that are received by the receiver, outputting the time indication responsive to the lamp receiving the activation signal; and
communicating a status signal responsive to the lamp receiving the activation signal using a communication device of the signaling lamp assembly, the status signal indicating the status of the wayside device and the time indication.

13. The method of claim 12, further comprising generating the time indication and the status signal while the lamp receives the activation signal, and not generating the time indication and the status signal while the lamp does not receive the activation signal.

14. The method of claim 12, further comprising generating the light in a designated color or pattern to indicate the status of a light signal as the wayside device.

15. The method of claim 12, further comprising communicating the status signal to indicate a state of a switch disposed at an intersection between two or more routes.

16. The method of claim 12, further comprising determining a geographic location based on the timing signals and sending the geographic location in the status signal.

17. The method of claim 12, further comprising wirelessly transmitting or broadcasting the status signal to one or more vehicles.

18. The method of claim 17, further comprising wirelessly communicating the status signal to the one or more vehicles while the signaling lamp assembly is not visible to the one or more vehicles.

19. A method, comprising:
generating a first signal using a signaling assembly responsive to receiving an activation signal, the first signal indicative of a status of a wayside device;
receiving timing signals at a receiver of the signaling assembly from one or more remote signal sources;
outputting a time indication based on the timing signals that are received by the receiver, outputting the time indication responsive to the signaling assembly receiving the activation signal; and
communicating a status signal responsive to the signaling assembly receiving the activation signal using a communication device of the signaling assembly, the status signal indicating the status of the wayside device and the time indication.

20. The method of claim 19, further comprising wirelessly transmitting or broadcasting the status signal to one or more vehicles.
